(19) United States
(12) Patent Application Publication
(10) Pub. No.: US 2023/0173892 A1
(43) Pub. Date: Jun. 8, 2023

(54) REFRIGERANT CIRCULATING APPARATUS FOR VEHICLE

(71) Applicants: Hyundai Motor Company, Seoul (KR); Kia Corporation, Seoul (KR)

(72) Inventors: Yeonho KIM, Seoul (KR); Hochan AN, Hwaseong-si (KR); Hoyoung JEONG, Daegu (KR); Man Hee PARK, Suwon-si (KR); Jae Yeon KIM, Hwaseong-si (KR); Jeawan KIM, Hwaseong-si (KR)

(73) Assignees: Hyundai Motor Company, Seoul (KR); Kia Corporation, Seoul (KR)

(21) Appl. No.: 17/726,956

(22) Filed: Apr. 22, 2022

(30) Foreign Application Priority Data
Dec. 8, 2021 (KR) 10-2021-0174828

(51) Int. Cl. B60H 1/32

(52) U.S. Cl. CPC B60H 1/3229; B60H 1/3223; B60H 1/3227

(57) ABSTRACT

A refrigerant circulating apparatus for a vehicle, includes: at least one heat exchanger configured to heat-exchange a refrigerant; at least one valve provided to selectively flow the refrigerant to the at least one heat exchanger; and a refrigerant distribution unit having a first surface on which the at least one heat exchanger is mounted and a second surface on which the at least one valve is mounted, wherein the refrigerant distribution unit includes a plurality of flow paths therein to flow the refrigerant to the at least one heat exchanger according to selective operation of the at least one valve.

### CROSS-REFERENCE TO RELATED APPLICATION

The present application claims priority to Korean Patent Application No. 10-2021-0174828, filed on Dec. 8, 2021, the entire contents of which is incorporated herein for all purposes by this reference.

### BACKGROUND OF THE PRESENT DISCLOSURE

### Field of the Present Disclosure

The present disclosure relates to a refrigerant circulating apparatus for a vehicle, and more particularly, to a refrigerant circulating apparatus for a vehicle, which is included in an air conditioning system applied for indoor cooling and heating of a purpose built vehicle (PBV), and capable of minimizing use of piping while improving mountability of each constituent element.

### Description of Related Art

Recently, the vehicle industry has been introducing a new concept of future mobility vision for realizing a human-centered and dynamic future city.

One of these future mobility solutions is a purpose built vehicle (PBV) as purpose-based mobility.

The PBV indicates an eco-friendly mobility solution that provides customized services for occupants while they travel to their destination on the ground, and may set optimal paths for each situation and perform platooning using electric vehicle-based artificial intelligence.

In other words, the PBV is a means of transportation and a fixed facility with case-related techniques, and a separate driver seat is unnecessary as it has an autonomous driving function. Furthermore, an indoor space thereof has infinite expandability.

Such a PBV may not only perform a role of a shuttle that moves a large number of people, but may also be changed to a recreational space such as a restaurant, a cafe, a hotel, and a movie theater, and an essential facility such as a hospital and a pharmacy.

Herein, the PBV is powered by an electric motor, and is formed to include a skateboard-like rolling chassis (referred to as an underbody or skateboard in the art) with batteries spreading on a lower portion thereof and an upper body where occupants can board.

The PBV configured as described above is provided with an air conditioning system for controlling the indoor temperature of the upper body, and in the instant case, it is difficult to position components included in a refrigerant circulating apparatus of the air conditioning system in a narrow mounting space, and a layout of pipes through which a refrigerant flows becomes complicated.

Furthermore, some components of the refrigerant circulating apparatus may be mounted on the upper body due to limitation of the mounting space of the rolling chassis, and thus an internal space of the upper body is reduced.

To solve these problems, there is a need to develop a technique for mounting on a rolling chassis by simplifying piping of the refrigerant circulating apparatus and promoting modularization.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a refrigerant circulating apparatus configured for a vehicle, which is included in an air conditioning system applied for indoor cooling and heating of a purpose built vehicle (PVB), and configured for minimizing use of piping while improving mountability of each constituent element.

Various aspects of the present disclosure are directed to providing a refrigerant circulating apparatus for a vehicle, including: at least one heat exchanger configured to heat-exchange a refrigerant; at least one valve provided to selectively flow the refrigerant to the at least one heat exchanger; and a refrigerant distribution unit having a first surface on which the at least one heat exchanger is mounted and a second surface on which the at least one valve is mounted, wherein the refrigerant distribution unit includes a plurality of flow paths therein to flow the refrigerant to the at least one heat exchanger according to selective operation of the at least one valve.

The refrigerant distribution unit may include: a first plate having a plurality of first penetration holes that is formed to correspond to the at least one heat exchanger, a first surface on which the at least one heat exchanger is mounted, and a second surface on which a plurality of first grooves selectively fluidically-connectable to the first penetration holes is formed; and a second plate coupled to the first plate, and having a plurality of second penetration holes that is formed to correspond to the at least one valve, a first surface on which the at least one valve is mounted, and a second surface on which a plurality of second grooves selectively fluidically-connectable to the second penetration holes is formed.

The first grooves and the second grooves may be formed to have a same shape.

The first grooves and the second grooves form the plurality of flow paths through which the refrigerant flows in a state in which the second surfaces of the first plate and the second plate are coupled to each other.

The second plate may further include at least one mounting portion protruding from the first surface of the second plate on which the at least one valve is mounted.

The at least one mounting portion may be formed with connection holes fluidically-communicating with the second grooves.

The first plate and the second plate may be formed to have a same shape.

The at least one heat exchanger may condense or evaporate the refrigerant introduced thereto through heat-exchange with a coolant.

The at least one heat exchanger may include: a first heat exchanger configured to condense or evaporate a refrigerant selectively supplied from the compressor; and a second heat exchanger configured to condense or evaporate the refrigerant selectively supplied from the compressor or the first heat exchanger.

The at least one valve may include: a first valve connected to the compressor and the first and second heat exchangers through the flow paths to selectively introduce the refrigerant supplied from the compressor into the first heat exchanger or the second heat exchanger; and a second valve connected to the first heat exchanger and the second heat exchanger through the flow paths.

It may further include a gas-liquid separator configured to separate a gaseous refrigerant or a liquid refrigerant from the refrigerant condensed or evaporated while passing through the at least one heat exchanger.

The gas-liquid separator may be is connected to the first valve through the flow paths, and may be connected to the compressor.

The second valve may control a flow of the refrigerant or selectively expand the introduced refrigerant.

The refrigerant distribution unit may be connected to the compressor provided outside through a connection member.

As described above, in accordance with the refrigerant circulating apparatus for a vehicle according to the exemplary embodiment of the present disclosure, which is included in an air conditioning system applied for indoor cooling and heating of a purpose built vehicle (PVB), it is possible to reduce a manufacturing cost by minimizing use of piping while improving mountability of each constituent element.

Furthermore, according to an exemplary embodiment of the present disclosure, it is possible to minimize heat loss which may occur while the refrigerant moves by minimizing the use of a pipe through which the refrigerant is circulated.

According to an exemplary embodiment of the present disclosure, it is also possible to simplify a layout in a narrow space in the front of a vehicle, and improve mountability, assembling ability, and maintainability by promoting modularization of the refrigerant circulating apparatus.

Furthermore, according to an exemplary embodiment of the present disclosure, it is possible to maximize an indoor space of a vehicle which may be applied for various purposes by mounting the refrigerant circulating apparatus modularized in a purpose built vehicle (PBV) on a vehicle body.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a schematic diagram of a refrigerant circulating apparatus for a vehicle according to various exemplary embodiments of the present disclosure.

FIG. 2 illustrates a front perspective view of a refrigerant circulating apparatus for a vehicle according to various exemplary embodiments of the present disclosure.

FIG. 3 illustrates a rear projection perspective view of a refrigerant circulating apparatus for a vehicle according to various exemplary embodiments of the present disclosure.

FIG. 4 illustrates a front perspective view of a refrigerant distribution unit applied to a refrigerant circulating apparatus for a vehicle according to various exemplary embodiments of the present disclosure.

FIG. 5 illustrates a rear perspective view of a refrigerant distribution unit applied to a refrigerant circulating apparatus for a vehicle according to various exemplary embodiments of the present disclosure.

FIG. 6 illustrates an exploded perspective view of a refrigerant distribution unit applied to a refrigerant circulating apparatus for a vehicle according to various exemplary embodiments of the present disclosure.

FIG. 7 illustrates a view for describing an operation of a refrigerant circulating apparatus for a vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Various exemplary embodiments of the present disclosure will hereinafter be described in detail with reference to the accompanying drawings.

Since the embodiments described in the specification and the configurations shown in the drawings are merely the most preferable embodiments and configurations of the present disclosure, they do not represent all of the technical ideas of the present disclosure, and it should be understood that various equivalents and modified examples, which may replace the embodiments, are possible, when filing the present application.

In order to clearly describe the present disclosure, parts that are irrelevant to the description are omitted, and identical or similar constituent elements throughout the specification are denoted by the same reference numerals.

Since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Furthermore, throughout the specification, unless explicitly described to the contrary, the word “comprise” and variations such as “comprises” or “comprising” will be understood to imply the inclusion of stated elements but not the exclusion of any other elements.

Furthermore, terms such as “. unit”, “. means”, “. part”, and “. member” described in the specification mean a unit of a comprehensive configuration including at least one function or operation.

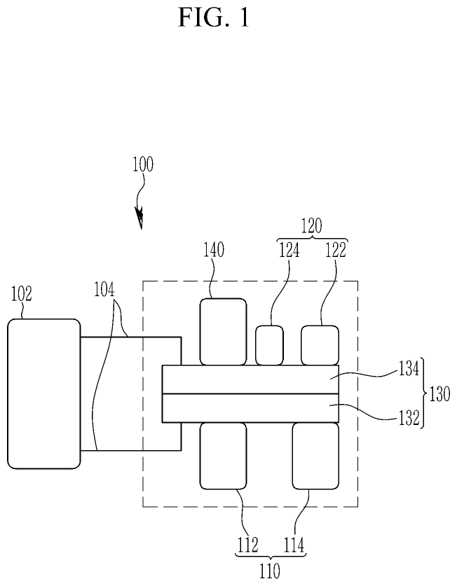

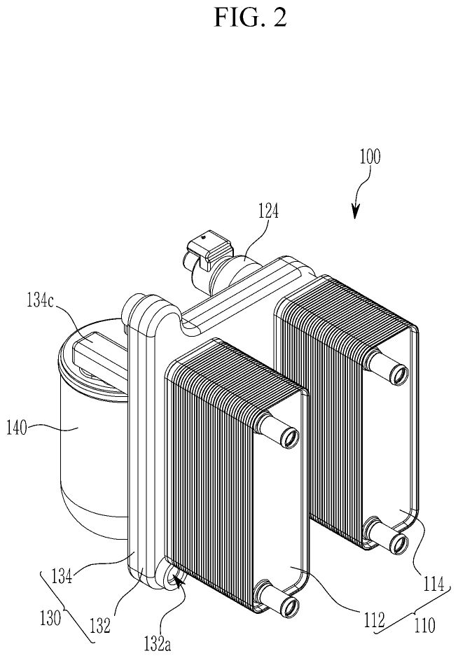

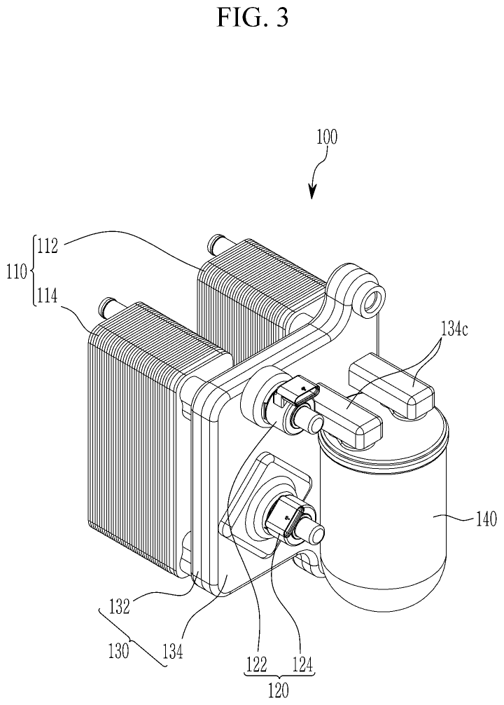

FIG. 1 illustrates a schematic diagram of a refrigerant circulating apparatus for a vehicle according to various exemplary embodiments of the present disclosure, FIG. 2 illustrates a front perspective view of a refrigerant circulating apparatus for a vehicle according to various exemplary embodiments of the present disclosure, and FIG. 3 illustrates a rear projection perspective view of a refrigerant circulating apparatus for a vehicle according to various exemplary embodiments of the present disclosure.

Various exemplary embodiments of the present disclosure may be applied to, e.g., purpose-based mobility (purpose built vehicle: hereinafter referred to as PBV).

The PBV is an electric vehicle-based eco-friendly mobile vehicle that provides customized services required for passengers while they travel to their destination on the ground.

The PBV may be configured for setting an optimal path for each situation and performing platooning, and furthermore, may be a box-type design vehicle including a large internal space.

Such a PBV includes a skateboard-like rolling chassis (also referred to as an underbody in the art) and an upper body mounted on the rolling chassis.

A battery assembly may be mounted on the rolling chassis, and a driving motor may be provided.

Referring to FIG. 1 to FIG. 3, according to the exemplary embodiment of the present disclosure, the refrigerant circulating apparatus 100 is provided in an air conditioning system applied for indoor cooling and heating of a purpose built vehicle (PBV), configured for reducing a manufacturing cost by minimizing use of piping while improving mountability of each constituent element.

To the present end, the refrigerant circulating apparatus 100 according to the exemplary embodiment of the present disclosure includes at least one heat exchanger 110, at least one valve 120, and a refrigerant distribution unit 130.

First, the at least one heat exchanger 110 may heat-exchange a refrigerant.

The at least one heat exchanger 100 condenses or evaporates the refrigerant introduced therein through heat-exchange with a coolant.

That is, the at least one heat exchanger 100 may be a water-cooled heat exchanger for exchanging the introduced refrigerant with the coolant.

In the exemplary embodiment of the present disclosure, the at least one valve 120 may be provided to selectively flow the refrigerant through the at least one heat exchanger 110.

The at least one valve 120 may control a flow of the refrigerant or may selectively expand the introduced refrigerant.

Furthermore, the at least one heat exchanger 110 and the at least one valve 120 may be respectively mounted on a first surface and a second surface of the refrigerant distribution unit 130.

A plurality of flow paths 131 may be provided to flow the refrigerant to the at least one heat exchanger 110 by selective operation of the at least one valve 120 inside the refrigerant distribution unit 130.

In the exemplary embodiment of the present disclosure, the at least one heat exchanger 110 may include a first heat exchanger 112 and a second heat exchanger 114.

First, the first heat exchanger 112 may condense or evaporate the refrigerant selectively supplied from the compressor 102.

Furthermore, the second heat exchanger 114 may condense or evaporate the refrigerant selectively supplied from the compressor 102 or the first heat exchanger 112.

Herein, the refrigerant may be selectively supplied to the first heat exchanger 112 from the second heat exchanger 114 by operation of the at least one valve 120.

That is, the first heat exchanger 112 and the second heat exchanger 114 may be interconnected through the flow paths 131 of the refrigerant distribution unit 130 by the action of the at least one valve 120.

The refrigerant may be selectively supplied from the compressor 102 to the first heat exchanger 112 and the second heat exchanger 114 configured in the instant way by the at least one valve 120 operating depending on the heating mode or the cooling mode of the vehicle.

For example, when the refrigerant is supplied from the compressor 102 to the first heat exchanger 112, the refrigerant that has passed through the first heat exchanger 112 may flow into the second heat exchanger 114.

On the other hand, when the refrigerant is supplied from the compressor 102 to the second heat exchanger 114, the refrigerant that has passed through the second heat exchanger 114 may flow into the first heat exchanger 112.

Meanwhile, in an exemplary embodiment of the present disclosure, the at least one valve 120 may include a first valve 122 and a second valve 124.

First, the first valve 122 may be connected to the compressor 102 and the first and second heat exchangers 112 and 114 through the flow passages 131 to selectively introduce the refrigerant supplied from the compressor 102 into the first heat exchanger 112 or the second heat exchanger 114.

Herein, the first valve 122 may be a four-way valve.

Furthermore, the second valve 124 may be connected to the first heat exchanger 112 and the second heat exchanger 114 through the flow paths 131.

In an exemplary embodiment of the present disclosure, the second valve 124 may control a flow of the refrigerant or may selectively expand the introduced refrigerant.

That is, the second valve 124 may control a flow of the refrigerant introduced from the first heat exchanger 112 or the second heat exchanger 114, and may selectively expand the introduced refrigerant to introduce it into the first heat exchanger 112 or the second heat exchanger 114.

The first and second valves 122 and 124 configured in the instant way may be mounted on the refrigerant distribution unit 130.

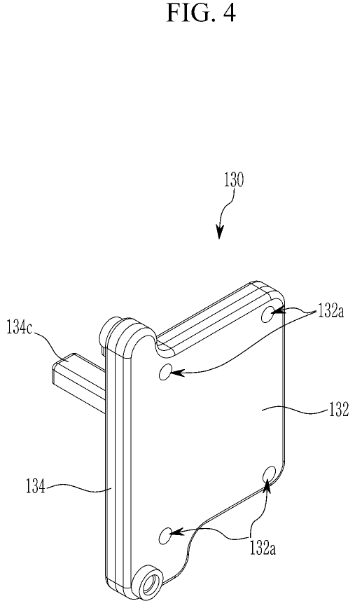

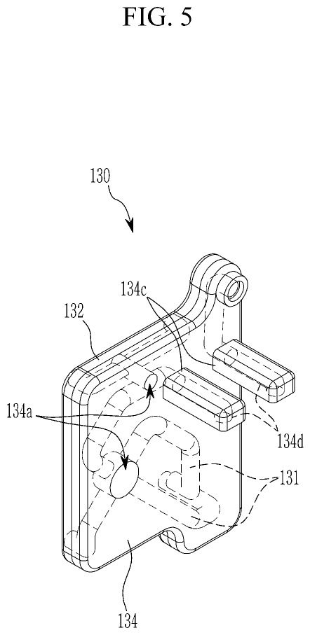

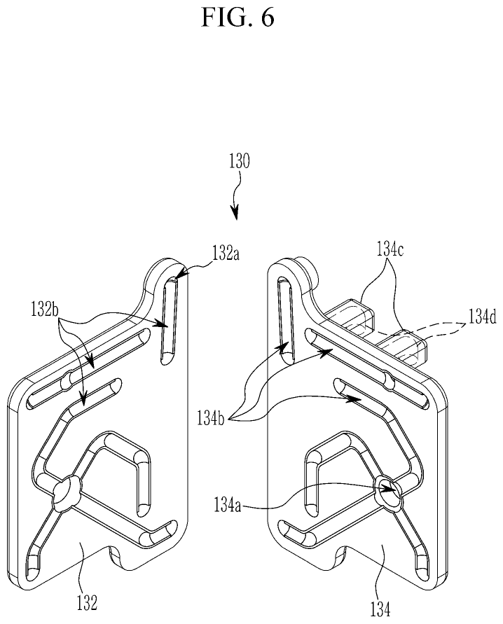

Hereinafter, the refrigerant distribution unit 130 according to various exemplary embodiments of the present disclosure will be described in more detail with reference to FIG. 4, FIG. 5, and FIG. 6.

FIG. 4 illustrates a front perspective view of a refrigerant distribution unit applied to a refrigerant circulating apparatus for a vehicle according to various exemplary embodiments of the present disclosure, FIG. 5 illustrates a rear perspective view of a refrigerant distribution unit applied to a refrigerant circulating apparatus for a vehicle according to various exemplary embodiments of the present disclosure, and FIG. 6 illustrates an exploded perspective view of a refrigerant distribution unit applied to a refrigerant circulating apparatus for a vehicle according to various exemplary embodiments of the present disclosure.

Referring to FIG. 4, FIG. 5, and FIG. 6, the refrigerant distribution unit 130 according to the exemplary embodiment of the present disclosure includes a first plate 132 and a second plate 134.

First, in the first plate 132, a plurality of first penetration holes 132a may be formed to correspond to the first and second heat exchangers 112 and 114.

The first heat exchanger 112 and the second heat exchanger 114 may be respectively mounted on a first surface of the first plate 132 through the first penetration holes 132a.

Furthermore, a plurality of first grooves 132b selectively fluidically-connectable to the first penetration holes 132a may be formed on a second surface of the first plate

The second plate 134 may be mutually coupled to the first plate 132, and a plurality of second penetration holes 134a may be formed to correspond to the first and second valves 122 and 124.

The first and second valves 122 and 124 may be mounted on the first surface of the second plate 134 through the second penetration holes 134a.

Furthermore, a plurality of second grooves 134b selectively fluidically-connectable to the second penetration holes 134a may be formed on a second surface of the second plate 134.

Herein, the first plate 132 and the second plate 134 may be formed to have a same shape.

Meanwhile, in an exemplary embodiment of the present disclosure, the first grooves 132b and the second grooves 134b may be formed to have the same shape as each other.

Furthermore, the first grooves 134b and the second grooves 134b may form the plurality of flow paths 131 through which the refrigerant flows in a state in which the first plate 132 and the second plate 134 are coupled.

Meanwhile, the second plate 134 may further include at least one mounting portion 134c protruding from a first surface on which the first and second valves 122 and 124 are mounted.

Connection holes 134d fluidically-communicating with the second grooves 134b may be formed in the mounting portion 134c. In an exemplary embodiment of the present disclosure, the mounting portion 134c may be configured as a pair.

The refrigerant distribution unit 130 configured in the instant way may be connected to the compressor 102 externally provided through a connection member 104.

Furthermore, the refrigerant circulating apparatus 100 may further include a gas-liquid separator 140 for separating a gaseous refrigerant or a liquid refrigerant from the refrigerant condensed or evaporated while passing through the first heat exchanger 112 or the second heat exchanger 114.

In an exemplary embodiment of the present disclosure, the gas-liquid separator 140 may be mounted on the mount portion 134c, and the refrigerant ejected from the first heat exchanger 112 or the second heat exchanger 114 through the connection holes 134c and flowing into the flow paths 131 may be introduced.

The gas-liquid separator 140 is connected to the first valve 122 through the flow paths 131, and may be connected to the compressor 102.

That is, the gas-liquid separator 140 may separate a gaseous refrigerant and a liquid refrigerant from the refrigerant that has passed through the first heat exchanger 112 or the second evaporator 114.

The gas-liquid separator 140 configured in the instant way may supply the gaseous refrigerant among the refrigerant introduced from the first evaporator 114 or the second evaporator 116 to the compressor 102.

Accordingly, the gas-liquid separator 140 may supply only the gaseous refrigerant to the compressor 102, improving efficiency and durability of the compressor 102.

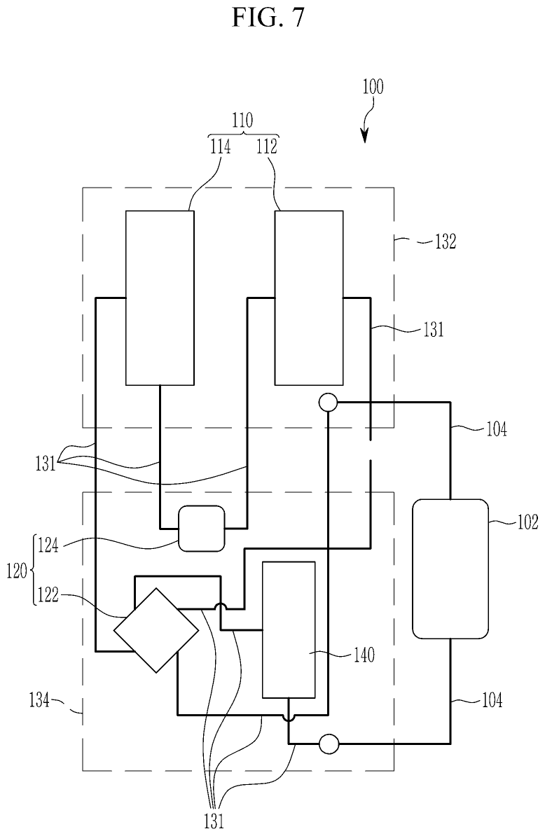

Hereinafter, an operation of the refrigerant circulating apparatus 100 configured as described above will be described with reference to FIG. 7.

In an exemplary embodiment of the present invention, the first port, the second port, the third port and the fourth port in the four-way valve of the first valve 122 are connected to the second heat exchanger 114, the compressor 102, the first heat exchanger 112 and the gas-liquid separator 140, respectively.

FIG. 7 illustrates a view for describing an operation of a refrigerant circulating apparatus for a vehicle according to various exemplary embodiments of the present disclosure.

Referring to FIG. 7, when an air conditioning system operates in accordance with various selected modes such as a cooling mode, a heating mode, or a dehumidification mode of the vehicle, the refrigerant is supplied from the compressor 102 to the refrigerant circulating apparatus 100.

The supplied refrigerant flows into the refrigerant distribution unit 130 through the connection member 104.

The refrigerant introduced into the refrigerant distribution unit 130 is introduced into the first valve 122 through the flow paths 131. The first valve 122 may supply the refrigerant to the first heat exchanger 112 or the second heat exchanger 114 by selectively connecting the flow paths 131 in accordance with an operation of a controller.

For example, when the refrigerant is introduced into the first heat exchanger 112, the first valve 122 may supply the refrigerant to the flow paths 131 connected to the first heat exchanger 112.

The refrigerant flowing into the first heat exchanger 112 exchanges heat with a coolant, and then flows into the second valve 124 through the flow paths 131. The second valve 124 may selectively expand the introduced refrigerant to introduce it into the second heat exchanger 114.

The refrigerant flowing into second heat exchanger 114 exchanges heat with a coolant, and then flows back into the first valve 122 through the flow paths 131.

The first valve 122 introduces the refrigerant introduced from the second heat exchanger 114 into the gas-liquid separator 140, and the gas-liquid separator 140 may supply a gaseous refrigerant to the compressor 102.

Conversely, when the refrigerant is introduced into the second heat exchanger 114, the first valve 122 may supply the refrigerant to the flow paths 131 connected to the second heat exchanger 114.

The refrigerant flowing into the second heat exchanger 114 exchanges heat with a coolant, and then flows into the second valve 124 through the flow paths 131. The second valve 124 may selectively expand the introduced refrigerant to introduce it into the first heat exchanger 112.

The refrigerant flowing in the first heat exchanger 112 exchanges heat with a coolant, and then flows back into the first valve 122 through the flow paths 131.

The first valve 122 introduces the refrigerant introduced from the first heat exchanger 112 into the gas-liquid separator 140, and the gas-liquid separator 140 may supply a gaseous refrigerant to the compressor 102.

While repeatedly performing such operations, the refrigerant circulating apparatus 100 may circulate the refrigerant supplied from the compressor 102.

Accordingly, when the refrigerant circulating apparatus for a vehicle according to the exemplary embodiment of the present disclosure configured as described above, which is included in an air conditioning system applied for indoor cooling and heating of a purpose built vehicle (PVB), is applied, it is possible to reduce a manufacturing cost by minimizing use of piping while improving mountability of each constituent element.

Furthermore, according to an exemplary embodiment of the present disclosure, it is possible to minimize heat loss which may occur while the refrigerant moves by minimizing the use of a pipe through which the refrigerant is circulated.

According to an exemplary embodiment of the present disclosure, it is also possible to simplify a layout in a narrow space in the front of a vehicle, and improve mountability, assembling ability, and maintainability by promoting modularization of the refrigerant circulating apparatus 100.

Furthermore, according to an exemplary embodiment of the present disclosure, it is possible to maximize an indoor space of a vehicle which may be applied for various purposes by mounting the refrigerant circulating apparatus 100 modularized in a purpose built vehicle (PBV) on a vehicle body.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A refrigerant circulating apparatus comprising:
at least one heat exchanger configured to heat-exchange a refrigerant;
at least one valve provided to selectively flow the refrigerant to the at least one heat exchanger; and
a refrigerant distribution unit having a first surface on which the at least one heat exchanger is mounted and a second surface on which the at least one valve is mounted,
wherein the refrigerant distribution unit includes a plurality of flow paths therein to flow the refrigerant to the at least one heat exchanger according to selective operation of the at least one valve.

2. The refrigerant circulating apparatus of claim 1, wherein the refrigerant distribution unit further includes:
a first plate having a plurality of first penetration holes that is formed to correspond to the at least one heat exchanger, a first surface on which the at least one heat exchanger is mounted, and a second surface on which a plurality of first grooves selectively fluidically-connectable to the first penetration holes is formed; and
a second plate coupled to the first plate, and having a plurality of second penetration holes that is formed to correspond to the at least one valve, a first surface on which the at least one valve is mounted, and a second surface on which a plurality of second grooves selectively fluidically-connectable to the second penetration holes is formed.

3. The refrigerant circulating apparatus of claim 2, wherein the first grooves and the second grooves are formed to have a same shape.

4. The refrigerant circulating apparatus of claim 2, wherein the first grooves and the second grooves form the plurality of flow paths through which the refrigerant flows into a state in which the second surfaces of the first plate and the second plate are coupled to each other.

5. The refrigerant circulating apparatus of claim 2, wherein the second plate further includes at least one mounting portion protruding from the first surface of the second plate on which the at least one valve is mounted.

6. The refrigerant circulating apparatus of claim 5, wherein the at least one mounting portion is formed with connection holes fluidically-communicating with the second grooves.

7. The refrigerant circulating apparatus of claim 6, wherein a gas-liquid separator is mounted on the at least one mount portion.

8. The refrigerant circulating apparatus of claim 2, wherein the first plate and the second plate are formed to have a same shape.

9. The refrigerant circulating apparatus of claim 1, wherein the at least one heat exchanger condenses or evaporates the refrigerant introduced thereto through heat-exchange with a coolant.

10. The refrigerant circulating apparatus of claim 1, wherein the at least one heat exchanger includes:
a first heat exchanger configured to condense or evaporate the refrigerant selectively supplied from a compressor; and
a second heat exchanger configured to condense or evaporate the refrigerant selectively supplied from the compressor or the first heat exchanger.

11. The refrigerant circulating apparatus of claim 10, wherein the at least one valve includes:
a first valve connected to the compressor and the first and second heat exchangers through the flow paths to selectively introduce the refrigerant supplied from the compressor into the first heat exchanger or the second heat exchanger; and
a second valve connected to the first heat exchanger and the second heat exchanger through the flow paths.

12. The refrigerant circulating apparatus of claim 11, wherein the second valve is provided between the first heat exchanger and the second heat exchanger and connected thereto.

13. The refrigerant circulating apparatus of claim 11, further including a gas-liquid separator configured to separate a gaseous refrigerant or a liquid refrigerant from the refrigerant condensed or evaporated while passing through the at least one heat exchanger.

14. The refrigerant circulating apparatus of claim 13, wherein the gas-liquid separator is connected to the first valve through the flow paths, and is connected to the compressor.

15. The refrigerant circulating apparatus of claim 13, wherein the first valve is a four-way valve including a first port, a second port, a third port and a fourth port.

16. The refrigerant circulating apparatus of claim 15, wherein the first port, the second port, the third port and the fourth port of the four-way valve are connected to the second heat exchanger, the compressor, the first heat exchanger and the gas-liquid separator, respectively.

17. The refrigerant circulating apparatus of claim 11, wherein the second valve controls a flow of the refrigerant or selectively expands the introduced refrigerant.

18. The refrigerant circulating apparatus of claim 1, wherein the refrigerant distribution unit is connected to a compressor provided outside through a connection member.
